(19) United States
(12) Patent Application Publication
(10) Pub. No.: US 2012/0291633 A1
(43) Pub. Date: Nov. 22, 2012

(54) BEVERAGE MACHINE

(75) Inventors: Frank Goeltenboth, Blaustein (DE); Alexander Kiefer, Kuchen (DE); Oliver Schneider, Geislingen/Steige (DE); Heinz Albert, Laichingen (DE); Johannes Bais, Ulm (DE)

(73) Assignee: WMF Wuerttembergische Metallwarenfabrik AG, Geislingen/Steige (DE)

(21) Appl. No.: 13/476,201

(22) Filed: May 21, 2012

(30) Foreign Application Priority Data
May 20, 2011 (DE) 10 2011 076 216.7

(51) Int. Cl. A47J 31/46

(52) U.S. Cl. 99/280; 99/300

(57) ABSTRACT

A beverage machine (1) or a preparation machine, in particular a coffee machine has a main flow path (5) that leads from a line connection or a tank (2) through a boiler (3) to a dispensing location (4). The boiler (3) is connected to the tank (2), to a drip pan (8), to a drain or a dispensing location via a line (7) that encompasses a valve (6). In the case of a boiler (3) that is in the stand-by state, the valve (6) is at least partially open, whereby an unpressurized, open boiler system is at hand. A control device (9), actuates the valve (6) and closes the valve (6) provided that a demand is at hand. A combination of the advantages of a closed and of an open boiler system is possible through this.

### BACKGROUND OF THE INVENTION

1. Field of the Invention

The instant invention relates to a beverage machine or to other preparation machines, in particular to a coffee machine, comprising a main flow path, which leads from a line connection or a tank through a boiler to a dispensing location.

2. Description of the Related Art

Coffee machines and in particular so-called fully automatic machines range from advantageous household models to professional appliances in the gastronomy. In the individual price ranges, the coffee machines are equipped with different water heating systems, so as to do justice to the respective market price. Advantageous continuous-flow water heaters that require little or even no energy at all during standstill and that heat the water only as needed, can be found in most household appliances. The heating time and the temperature control are acceptable for the household area. The situation is different in the gastronomy, where the demands on quality and performance are typically higher. The beverage delivery is to take place immediately and the temperature is to be held as accurately as possible. For this reason, boiler and kettle systems can often be found in the coffee machines in this area. In the average-price market, such as for office use and in smaller companies with client reception areas, the product range is less diverse in comparison. Continuous-flow water heaters require too much time here for a metering, whereas the complete (closed) boiler systems are oversized.

The boiler systems that are on the market include closed boiler systems and open boiler systems. Closed boiler systems are comparatively extensive and thus expensive because, the medium expands in response to the heating. As a result, the pressure in the boiler can increase sharply and the boiler must thus be designed for this pressure increase. For this reason, a so-called relieving valve is installed as well, which opens during the heating process (without removal). If the relieving valve is defective, however, provision must be made for at least one safety valve, which reliably discharges the excessive pressure. The safety valve, the relieving valve as well as the entire boiler are thereby subject to cyclical maintenance and inspections, whereby all of the plug connections must additionally be subjected to a defined pressure inspection. It goes without saying that all of these measures create high costs. Open boiler systems, however, do not require the mentioned safety systems, such as relieving valves or safety valves, for example, because the water has a sufficient relieving volume to the atmosphere. In the case of open boiler systems, an uncontrolled and dangerous pressure can thus not be created. The large disadvantage in the case of an open boiler system, however, are the enormous energy losses during the stand-by operation. Due to the fact that the boiler is open, the medium, in particular the water, constantly discharges energy into its surrounding area at its surface. For conveying the medium, for example the water, the pump is installed downstream from the boiler and thus conveys heated medium or water, respectively, whereby higher costs in the area of the pump are created.

The instant invention thus deals with the problem of specifying an improved embodiment for a beverage machine, in particular in the average price range that is cost-efficient and that satisfies high quality demands in terms of the beverage, that is to be made.

### SUMMARY OF THE INVENTION

The instant invention is based on the general idea of combining the advantages of an open boiler system with the advantages of a closed boiler system for a beverage machine, or a preparation machine. Generally, this means that the beverage machine or preparation machine, respectively, according to the invention encompasses a boiler that is connected to a water tank, a drip pan, a drain or a dispensing location via a line that encompasses a valve. The boiler itself is arranged in a main flow path between a line connection or a water tank and a dispensing location. In the case of a boiler that is in the stand-by state, the valve at least partially open, whereby an unpressurized, open boiler system is present. Provision is furthermore made for a control device that actuates the valve and that closes the valve, provided that a beverage delivery and thus a hot water demand are at hand. During the operation of the beverage machine, the control device thus transfers the boiler system, which is open in the stand-by state, into a closed boiler system. In the stand-by state, the connection to the surrounding area is thereby reduced to a minimum, so that an undesirably large energy discharge and thus a high energy consumption are thus not present. Due to the at least partially open valve, it is nonetheless always ensured in the stand-by state that the maximum heat energy that can be supplied, and thus the steam that is generated can be discharged reliably. The valve can be a so-called “normally open” (NO) valve comprising a corresponding inner diameter. The beverage machine of the invention thereby includes the following significant advantages:
savings of safety valves and compression-proof valves,
reduction of high pressure demands on the boiler, which contributes to cost savings,
immediate hot water delivery is possible in response to a corresponding hot water demand, because the medium in the boiler is always kept at a predefined temperature,
the control device can be replaced by a parallel connection of the (relieving) valve to the pump,
little energy loss in the stand-by state, because a substantially closed boiler system is at hand in the stand-by state,
a high dynamic, because temperature and pressure constancy lies within required tolerances,
possibility to use a comparatively cost-efficient pump, because it is arranged upstream of the boiler and must not be designed for conveying hot mediums.

The valve additionally may be a pressure-discharging valve and thus opens from the closed state, starting at a predetermined pressure. In the event that a beverage request and thus a hot water demand is input at the beverage machine, the control device closes the valve located at the boiler or in the line, respectively, and actuates the pump, whereupon the control device increases the pressure in the boiler and thus conveys hot medium from the boiler to the dispensing location. In the event that the pressure in the boiler thereby rises unexpectedly quickly and high, the valve, which is embodied as a pressure-discharging valve, can take over a safety function here, in that it opens at a predetermined pressure and in particular discharges dangerous overpressure. The valve according to the invention thereby fulfills the function of a relieving valve in the stand-by state as well as the function of a safety valve during the operating state of the machine.

A bypass flow path that circumvents the boiler may be provided. The bypass flow path branches off from the main flow path upstream of the boiler and a bypass flow pump or a valve or a cover is arranged in the bypass flow path. By means of the bypass flow path, which circumvents the boiler, a cold medium conveyance, that is, a cold water conveyance, is generally also possible, whereby the beverage machine is also suitable for dispensing cold beverages. Generally speaking, it goes without saying that not only water must be heated in the boiler, but that this system can generally also be used to heat other mediums, such as milk, etc., for example.

Further important features and advantages of the invention follow from the subclaims, from the drawings and from the corresponding description of the figures by means of the drawings.

It goes without saying that the above-mentioned features and the features, which will be defined below, cannot only be used in the respective specified combination, but also in other combinations or alone, without leaving the scope of the instant invention.

Preferred exemplary embodiments of the invention are illustrated in the drawings and will be defined in more detail in the following description, whereby the same reference numerals refer to the same components or to similar or functionally equal components.

### BRIEF DESCRIPTION OF THE DRAWINGS

FIG. 1 is a first possible embodiment of a beverage machine according to the invention.

FIG. 2 is an illustration similar to FIG. 1, but in the case of a further embodiment.

### DETAILED DESCRIPTION OF THE PREFERRED EMBODIMENTS

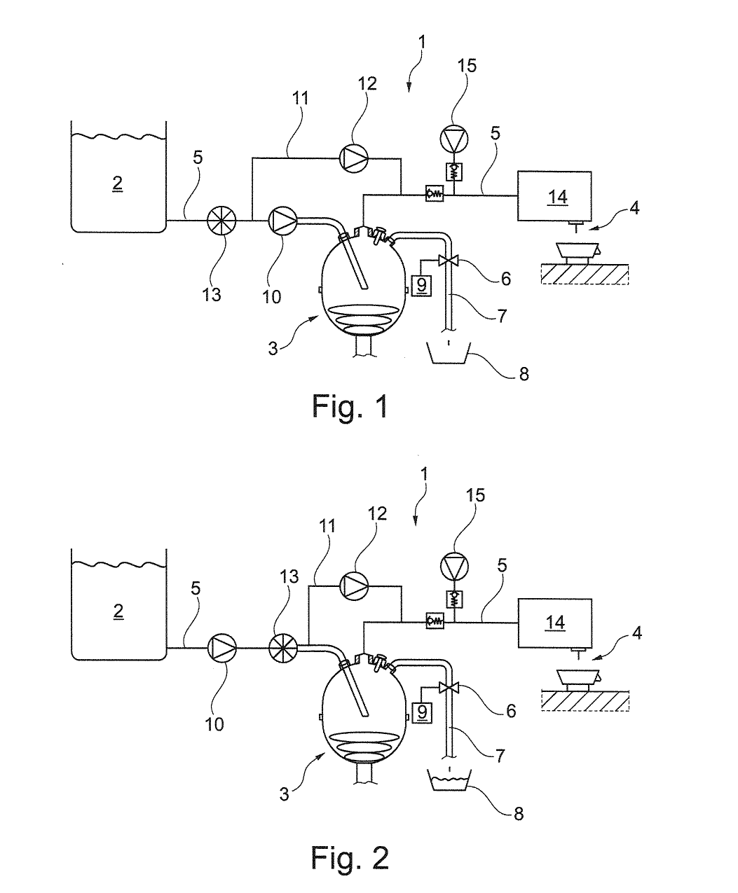

According to FIGS. 1 and 2, a beverage machine 1 according to the invention, which can be embodied as a fully automatic coffee machine, for example, encompasses a main flow path 5, which leads from a line connection or a tank 2 through a boiler 3 to a dispensing location 4. The boiler 3 is thereby connected to the tank 2, to a drip pan 8 or to a drain via a line 7, which encompasses a valve 6. It goes without saying that the valve 6 can thereby also be arranged directly on the boiler 3. In the event that the boiler 3 is in a stand-by state, the valve 6 is at least partially open, preferably virtually closed, whereby, due to the small opening cross section of the valve 6, comparatively little energy is needlessly discharged into the surrounding area on the one hand and an open boiler system is present on the other hand. In addition, provision is made for a control device 9, which actuates the valve 6 and which is embodied such that it closes the valve 6 provided that a beverage delivery and thus a hot water demand are at hand. By closing the valve 6, the boiler system, which was formerly open, is thus transferred into a closed boiler system. According to a further preferred embodiment, the valve 6 is at the same time embodied as a pressure-discharging valve and thereby opens out of the closed state, starting at a predefined pressure. For this reason, an uncontrolled pressure development cannot occur at any point in time within the boiler 3. The valve 6 can furthermore also adapt the opening to a pressure increase in the half-oven state.

When further considering FIGS. 1 and 2, it can be seen that provision is made in the main flow path 5 for a main flow pump 10 for conveying mediums through the boiler 3, which is arranged upstream of the boiler 3 and which must thus exclusively be embodied for conveying cold medium, that is, for conveying cold water, whereby the main flow pump 10 can generally be designed in a more cost-efficient manner than a comparable pump, which must convey hot water. For this reason, the beverage machine 1 according to the invention has a considerable cost advantage as compared to current open boiler systems.

It can also be seen that provision is made for a bypass flow path 11, which circumvents the boiler 3, whereby the bypass flow path 11 branches off from the main flow path 5 upstream of the boiler 3 and whereby a bypass flow pump 12 is arranged in the bypass flow path 11. It goes without saying that provision can also be made for a valve or a cover, instead of for the bypass flow pump 12, whereby the line cross section can also be used as cover. With the arrangement of the bypass flow pump 12 it is possible to convey only cold medium, that is, cold water, from the water tank 2 to the dispensing location 4 and to thus also prepare cold beverages. A fluid flow meter 13, for example a flow rate meter, can furthermore be arranged in the main flow path 5 downstream from or upstream of the main flow pump 10, whereby provision can furthermore be made downstream from the boiler 3 for a brewing device 14. As is shown according to FIG. 1, the bypass flow path 11 can thereby branch out of the main flow path 5 between the fluid flow meter 13 and the main flow pump 10 or downstream from the fluid flow meter 13 and thus between the latter and the boiler 3. It goes without saying that a return of the bypass flow path 11 into the main flow path 5 takes place downstream from the boiler 3. Generally, the bypass flow pump 12 and/or the main flow pump 10 can be embodied as vane-type pump, as gear-type pump, as magnetic piston pump or as another pump type.

The control device 9 can furthermore be embodied such that it controls or regulates, respectively, the bypass flow pump 12 as a function of a flow volume, a beverage temperature, a water temperature in the tank or a temperature in the main flow path 5 downstream from or upstream of the boiler 3. The arrangement of the bypass flow pump 12, of the main flow pump 10 as well as of the fluid flow meter 13 are thereby generally variable, whereby FIGS. 1 and 2 only show two possible embodiments.

To obtain a defined starting position to minimize metering fluctuations, the main flow path 5 downstream from the boiler 3 can additionally be blown out with air, for the purpose of which provision can be made for an air pump 15, for example.

In the case of the beverage machine 1 according to the invention, an open-closed boiler system was thus created, which is in the resting state, that is, in the open state in the stand-by state and in the closed state when beverages are delivered and which thus combines the advantages of an open boiler system as well as of a closed boiler system. The beverage machine according to the invention is furthermore characterized by low costs, caused by the savings of safety valves and the reduced pressure demands on the boiler 3, as well as by a considerably reduced energy consumption, because high energy losses do not occur in the stand-by state. By using a comparatively cost-efficient main flow pump 10, a cost reduction can furthermore be obtained. In spite of reduced costs, the output is considerably better than in the case of common continuous-flow water heaters, because an immediate delivery with simultaneously lower electrical outputs is possible. The medium, for example water, which is constantly heated in the boiler 3, thereby serves as buffer for the energy storage. At the same time, the beverage machine 1 according to the invention is also characterized by a high temperature and pressure constancy in the respectively demanded tolerance ranges.

What is claimed is:

1. A beverage machine (1) or preparation machine, comprising a main flow path (5) that leads from a line connection or a tank (2) through a boiler (3) to a dispensing location (4), the boiler (3) being connected to the tank (2), to a drip pan (8), to a drain or a dispensing location via a line (7) that includes a valve (6), the valve (6) being at least partially open when the boiler is in a stand-by state, and a control device (9) that actuates the valve (6) and closes the valve (6) provided that a demand is at hand.

2. The beverage machine of claim 1, wherein the valve (6) is a pressure-discharging valve and thus opens from the closed state, starting at a predetermined pressure.

3. The beverage machine of claim 1, further comprising that a main flow pump (10) for conveying mediums through the boiler (3) is arranged upstream of the boiler (3).

4. The beverage machine of claim 3, further comprising that a bypass flow path (11) that circumvents the boiler (3), the bypass flow path (11) branching off from the main flow path (5) upstream of the boiler (3) and a bypass flow pump (12) or a valve (6) or a cover being arranged in the bypass flow path (11).

5. The beverage machine of claim 4, further comprising a fluid flow meter (13) in the main flow path (5) downstream from or upstream of the main flow pump (10).

6. The beverage machine of claim 5, wherein the bypass flow path (11) branches off from the main flow path (5) between the main flow pump (10) and the fluid flow meter (13) or that the bypass flow path (11) branches off from the main flow path (5) between the fluid flow meter (13) and the boiler (3).

7. The beverage machine of claim 4, wherein at least one of the bypass flow pump (12) and the main flow pump (10) is a vane-type pump, a gear-type pump or a magnetic piston pump.

8. The beverage machine of claim 4, wherein the control device (9) controls/regulates the bypass flow pump (12) as a function of a flow volume, a beverage temperature, a water temperature in the tank (2) or a temperature in the main flow path (5) upstream of or downstream from the boiler (3).
